(19) United States
(12) Patent Application Publication
(10) Pub. No.: US 2016/0179195 A1
(43) Pub. Date: Jun. 23, 2016

(54) Method for operating a head-up display, presentation apparatus, vehicle

(71) Applicant: Robert Bosch GmbH, Stuttgart (DE)

(72) Inventors: Christian MOTZ, Ludwigsburg (DE); Alexander Mueller, Bietigheim (DE)

(21) Appl. No.: 14/970,195

(22) Filed: Dec. 15, 2015

(30) Foreign Application Priority Data
Dec. 22, 2014 (DE) 10 2014 226 860.5

(51) Int. Cl. G06F 3/01; G09G 3/00; G02B 27/01; G06F 3/0484

(52) U.S. Cl. CPC G06F 3/013; G06F 3/04845; G06F 3/04847; G09G 3/002; G02B 27/0101; G09G 2320/0626; G09G 2320/066; G09G 2380/10; G02B 2027/014; G02B 2027/0141

(57) ABSTRACT

A method for operating a head-up display of a vehicle, in particular of a motor vehicle, in which at least one information item is presented by the head-up display and the method encompassing the following: ascertaining the gaze direction of at least one eye of a driver; checking whether the gaze of the at least one eye of the driver is directed toward the head-up display; and modifying the presentation of the head-up display, in order to improve the readability of the at least one information item, if the gaze of the at least one eye of the driver is directed toward the presentation of the head-up display.

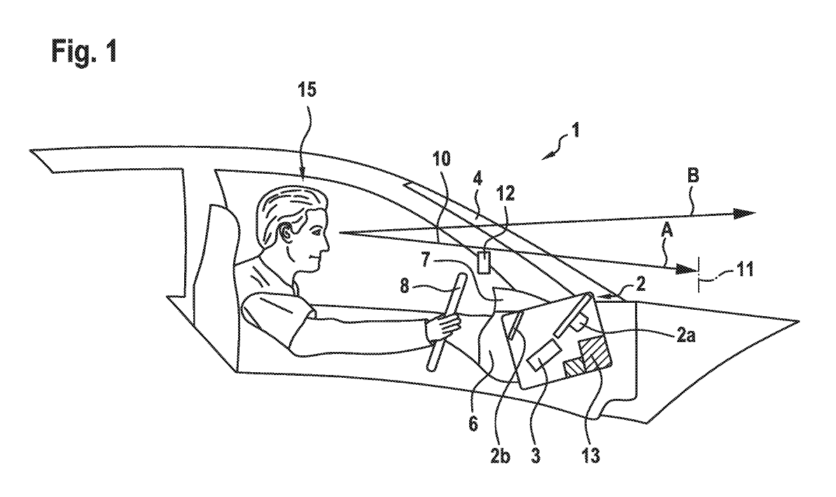

### RELATED APPLICATION INFORMATION

The present application claims priority to and the benefit of German patent application no. 10 2014 226 860.5, which was filed in Germany on Dec. 22, 2014, the disclosure of which is incorporated herein by reference.

### FIELD OF THE INVENTION

The present invention relates to a method for operating a head-up display of a vehicle, in particular of a motor vehicle, at least one information item being presented by the head-up display. The invention further relates to a presentation apparatus for a vehicle, in particular a motor vehicle, having a head-up display and having a control unit, and to a vehicle, in particular a motor vehicle, having the presentation apparatus.

### BACKGROUND INFORMATION

Head-up displays of the kind recited initially are known from the existing art. Head-up displays are in particular being used more frequently in motor vehicles in order to make it easier for a driver to monitor the most important driving parameters. A head-up display known from the existing art projects information items for this purpose onto the windshield in the lower region of a driver's field of view. The driver thus does not need to divert his or her gaze entirely away from the road in order to perceive the information items presented by a head-up display, but instead can merely direct his or her gaze slightly downward in order to focus on what is presented on the head-up display.

It is also known from DE 103 38 647 A1 that the position of a driver's head, or the gaze direction of his or her eyes, can be sensed via a sensor in order thereby to regulate the brightness of a light-emitting signal mounted in a mirror of a motor vehicle.

### SUMMARY OF THE INVENTION

The method according to the present invention having the technical features described herein has the advantage that automatic detection occurs as to whether a driver is looking at the presentation of a head-up display or at the road. It is thereby possible in particular for the presentation of the head-up display to be configured, in an idle state, i.e. a state in which the driver's gaze is not directed toward the head-up display, in such a way that the presentation of the head-up display is perceived very little or not at all by the driver, and for the presentation of the head-up display to be modified in such a way that the at least one information item presented thereon becomes readily readable by the driver only when the gaze of at least one of the driver's eyes is directed toward that presentation. The at least one presented information item is therefore intended to be almost or entirely undetectable and not readable when the presentation of the head-up display is in the idle state, and only as a result of the modification of the presentation is it to be presented to the driver so that it is clearly detectable and readable. In addition, the check as to whether the gaze of at least one of the driver's eyes is directed toward the presentation of the head-up display can be used to match other driver assistance functions thereto. For example, the driver can be warned more specifically of a hazardous traffic situation if he or she is looking at the presentation of the head-up display, for example by modifying the presentation of the head-up display and/or by shifting the point in time of the warning signal. Thanks to the method according to the present invention the driver is therefore less distracted by the presentation of the head-up display in the idle state, and moreover has more confidence for the case in which he or she is looking at the presentation of the head-up display, since he or she knows that he or she is being warned, by a change in the presentation of the head-up display and/or by a warning signal, about an impending hazardous traffic situation by way of a sensor located in or on the vehicle. This results in an improved user experience.

According to a refinement of the invention, provision is made that in order to modify the presentation, the contrast of the presentation is increased. Alternatively or additionally, provision may be made that in order to modify the presentation, the brightness of the presentation is increased. Alternatively or additionally, provision may be made that in order to modify the presentation, the sharpness of the presentation is increased. Alternatively or additionally, provision may be made that in order to modify the presentation, the at least one presented information item is enlarged.

In an embodiment of the present invention, when the gaze of at least one of the driver's eyes is directed toward the presentation of the head-up display, the presentation of the head-up display is modified in such a way that as compared with an idle state of the presentation of the head-up display, one or more characteristics, namely the contrast, brightness, and sharpness of the presentation, is increased, and/or the at least one information item presented in the presentation is enlarged. In the idle state the presentation of the head-up display is therefore less contrasty, less bright, and/or less sharp, and/or the at least one information item presented thereon is smaller, as compared with the modified state of the presentation of the head-up display. Only when the driver looks toward the head-up display are the information items depicted thereon presented to the driver in such a way that a brief perception time is sufficient for recognition and processing of the information. What advantageously results therefrom is that in the idle state, i.e. in normal driving operation, the driver perceives the presentation of the head-up display to be less disruptive, and he or she is less distracted by it.

This aforementioned technical effect is already achieved if, alternatively, the contrast, brightness or sharpness of the presentation is increased or the size of the presented information item is enlarged. If several or all of the aforementioned characteristics of the presentation are modified, however, the detectability of the presentation is additionally increased. In particular, the at least one information item depicted thereon is perceived by the driver in a very short time.

According to a refinement of the present invention, provision is made that the gaze direction of both of the driver's eyes is ascertained, and the presentation is modified only when the ascertainment of the gaze direction of both eyes indicates a focus on the presentation of the head-up display. For this, which may be the gaze directions of both of the driver's eyes are ascertained and a focus region, in particular a focus point, is calculated. A check is then made as to whether the focus region, which may be the focus point, of both of the driver's eyes coincides with the presentation of the head-up display. The term “focus point” is understood as the intersection point between the line of the gaze direction of the driver's one eye and the line of the gaze direction of the driver's other eye or, if these two lines do not intersect, the smallest distance between the two lines. The term “focus region” is understood as the region extending around the focus point. The focus region may extend at most 5 cm from the focus point and may constitute a spherical region, the center point being the focus point and the radius being equal to at most 5 cm.

Thanks to the fact that the gaze directions of both eyes, and a corresponding calculated focus onto the presentation of the head-up display, are ascertained, the presentation of the head-up display is modified only when the driver is looking at it. In this embodiment, when the presentation of the head-up display is being “looked through,” this advantageously does not result in a change in the presentation of the head-up display.

According to a refinement of the invention, provision is made that the head-up display is switched off if an impending hazardous traffic situation is detected by way of at least one, which may be exactly one, sensor located in or on the vehicle. The driver is accordingly informed, advantageously, of an impending hazardous driving situation even if he or she is looking at the presentation of the head-up display. Alternatively to this refinement of the present invention, it is also possible to shift the presentation of the head-up display into the idle state if a hazardous traffic situation is impending and if the gaze of at least one of the driver's eyes is directed toward the presentation of the head-up display, so as thereby to direct the driver's attention to the dangerous traffic situation.

The presentation apparatus according to the present invention having the features described herein is notable in particular for a detection apparatus and a control unit that, when utilized as intended, carries out the method according to the present invention. The advantages already recited above result therefrom. The presentation apparatus according to the present invention is, in particular, integrated into a vehicle, in particular a motor vehicle.

The vehicle, which may be a motor vehicle, according to the present invention, having the features described herein, is notable in particular for the presentation apparatus according to the present invention. The advantages already recited above result therefrom.

The invention will be explained in more detail below with reference to drawings.

### BRIEF DESCRIPTION OF THE DRAWING

The FIGURE is a schematic side view of a vehicle in longitudinal section.

### DETAILED DESCRIPTION

The single FIGURE shows a vehicle 1 having a head-up display 2 that is installed in a dashboard 6 of vehicle 1. An image generating unit 3 of head-up display 2 emits light via an imaging optic 2a, 2b onto a windshield 4. Windshield 4 reflects the imaging light of a beam path (not shown) toward the eyes of driver 15. Head-up display 2 depicts the image of the presented information item(s), via windshield 4, in such a way that driver 15 can perceive a presentation 11 of head-up display 2. Presentation 11 is disposed in alignment with the seated position of driver 15, steering wheel 8, and combination instrument 7, so that presentation 11 of head-up display 2 is detected principally when driver 15 is looking straight ahead through windshield 4. In addition, a detection apparatus 12, which in particular has a camera, a sensor, or a video camera, and optionally also a unit emitting an infrared beam, is disposed above driver 15 on vehicle 1. Detection apparatus 12 is positioned and embodied in such a way that it can detect and ascertain the gaze direction of at least one eye of driver 15, which may be the gaze directions of both eyes of driver 15. Detection apparatus 12 may be positioned below the driver's eyes so that the iris and pupils are not obscured by the eyelid. Detection apparatus 12 may therefore be embodied in a manner integrated into the dashboard. Alternatively, provision can be made, as shown in the FIGURE, for detection apparatus 12 to be integrated into the A pillar.

A control unit 13 is also present in vehicle 1. Control unit 13 can process the gaze direction, ascertained by sensing apparatus 12, of at least one of the driver's eyes and can check in that context whether the gaze of at least one eye of driver 15 is directed toward head-up display 2, in particular whether driver 15 is focusing on presentation 11 of head-up display 2. Provision can also be made that detection apparatus 12 is integrated into control unit 13.

For the case in which the gaze of at least one eye, which may be both eyes, of driver 15 is directed toward presentation 11 of head-up display 2 (indicated by arrow A), in particular is focused on it, presentation 11 is modified as compared with an idle state; this means in particular that its contrast, brightness, and/or sharpness is increased and/or that the size of the at least one information item presented thereon is increased, so that the at least one information item is more easily readable. If the gaze of driver 15 is not directed toward presentation 11 of head-up display 2 (indicated by arrow B), presentation 11 of head-up display 2 then either remains in its idle state or returns to that state if the driver has previously been looking toward presentation 11 of head-up display 2.

Methods for sensing the gaze direction of one or both eyes of a driver are known from the existing art. An infrared technique, among others, can be used for this. Here a weak infrared light beam of a stationary unit, which may be mounted on the dashboard of vehicle 1, that emits an infrared beam is directed onto the driver's eyes. After a calibration of the sensing apparatus which may be carried out, an image of at least one of the driver's eyes is recorded by a video camera, which image records both the pupil(s) and a reflection point of the infrared light from the cornea (called the “corneal reflection”). A corresponding software program then calculates the gaze direction from the relative spacing of the pupils and the corneal reflection.

The infrared source may be disposed very close to, in particular at a distance of less than 1 cm from, detection apparatus 12. Because illumination of the eye then occurs on almost the same optical axis as the sensing by detection apparatus 12, a sensed pupil appears in the image sensed by detection device 12 as a white disk, since light is reflected from the retina. Alternatively, provision may be made that the infrared source is disposed at a greater distance from the detection apparatus, in particular offset at least 10 to 15 cm from the camera. In particular, the infrared source is offset laterally from the camera or detection apparatus 12, so that it is mounted, for example, at the outermost lateral position of a combination instrument of vehicle 1. The infrared source then emits laterally onto the eye, so that the pupil appears as a black disk in the image acquired by detection apparatus 12.

What is claimed is:

1. A method for operating a head-up display of a vehicle, at least one information item being presented by the head-up display, the method comprising:
ascertaining a gaze direction of at least one eye of a driver;
checking whether the gaze of the at least one eye of the driver is directed toward the head-up display; and
modifying a presentation of the head-up display to improve the readability of the at least one information item, if the gaze of the at least one eye of the driver is directed toward the presentation of the head-up display.

2. The method of claim 1, wherein to modify the presentation, the contrast of the presentation is increased.

3. The method of claim 1, wherein to modify the presentation, the brightness of the presentation is increased.

4. The method of claim 1, wherein to modify the presentation, the sharpness of the presentation is increased.

5. The method of claim 1, wherein to modify the presentation, the at least one presented information item is enlarged.

6. The method of claim 1, wherein the gaze direction of both eyes of the driver is ascertained, and the presentation is modified only when the ascertainment of the gaze direction of both eyes indicates a focus on the presentation of the head-up display.

7. The method of claim 1, wherein the head-up display is switched off if an impending hazardous traffic situation is detected by way of at least one sensor located in or on the vehicle.

8. A presentation apparatus for a vehicle, having a head-up display and a control unit, comprising:
a sensing apparatus for operating the head-up display, at least one information item being presented by the head-up display, and being configured to perform the following:
ascertaining a gaze direction of at least one eye of a driver;
checking whether the gaze of the at least one eye of the driver is directed toward the head-up display; and
modifying a presentation of the head-up display to improve the readability of the at least one information item, if the gaze of the at least one eye of the driver is directed toward the presentation of the head-up display.

9. A vehicle, having a head-up display and a control unit, comprising:
a presentation apparatus, including a sensing apparatus for operating the head-up display, at least one information item being presented by the head-up display, and being configured to perform the following:
ascertaining a gaze direction of at least one eye of a driver;
checking whether the gaze of the at least one eye of the driver is directed toward the head-up display; and
modifying a presentation of the head-up display to improve the readability of the at least one information item, if the gaze of the at least one eye of the driver is directed toward the presentation of the head-up display.
